(19) United States
(12) Patent Application Publication
(10) Pub. No.: US 2013/0321912 A1
(43) Pub. Date: Dec. 5, 2013

(54) DEVICE FOR SIMULTANEOUS PRESENTATION OF MULTIPLE ITEMS OF INFORMATION TO RESPECTIVE, DIFFERENTLY SITUATED VIEWERS

(71) Applicant: Harald Igler, Hausen (DE)

(72) Inventor: Harald Igler, Hausen (DE)

(21) Appl. No.: 13/904,298

(22) Filed: May 29, 2013

(30) Foreign Application Priority Data
May 29, 2012 (DE) 102012208931.4

(51) Int. Cl. G02B 27/22

(52) U.S. Cl. CPC G02B 27/2214
USPC 359/463

(57) ABSTRACT

In a device to simultaneously present at least two items of information respectively associated with different persons, only to those persons located, at a single display device such as a monitor, the respective items of information are shown using the entire presentation area of the display device, and the presentation is made visible from the respective positions by the display device being provided with a lenticular film designed to show an image point presented on the display device only at a position that is associated with the intended viewer.

### BACKGROUND OF THE INVENTION

1. Field of the Invention

The present invention concerns a device for simultaneous presentation of at least two items of information that are respectively associated with a person, these items of information being presented to the persons arranged at different positions by a single display device (in particular a monitor), as well as a device to control a target device that includes a display device, such as a monitor, at which at least two different control presentations can be presented as information.

2. Description of the Prior Art

A category of devices with a method of the above type can be used to present information associated with persons to those persons located at clearly definable positions. This category is designated in the following as “presentation devices”. A device to control a device to be controlled (consequently a target device) is designated as a “control device”.

In many different situations and fields of application, configurations are known in which different items of information associated with the role of a respective person should be displayed to at least two persons, in particular during a conference. An example of this is a conference between a physician and a patient, in which the patient desires a view into a patient file or an annotated image data set of the patient while at the same time the unedited image (an x-ray image, for example) should be presented to the patient without the patient being diverted by additional information away from the actual features to be shown. Such a problem, in which persons having different roles during a conference should receive displayed information that is matched to them, is presently addressed by the display time of the information being divided between the persons. For example, a physician can activate a presentation of the information determined for the patient and turn a monitor to the patient in order to explain the matter. If the physician then rotates the monitor back, the physician can again call the information relevant for the physician's use by an appropriate operator action.

Another approach to this problem makes use of multiple display devices, of which one is associated with the person with one role and the other is associated with the person with the other role. The respective information associated with the respective persons is presented in the display device facing toward that person.

Both approaches have disadvantages. In the case of time partitioning, a disadvantage is that all information is never present simultaneously. For example, the physician must change the presentation in order to review information that is designated for him or her. In one variant with two display devices, the equipment cost is very high because expensive additional display devices and various control alternatives are required.

A related problem occurs in the control of devices to be controlled (target devices in the following, because they form the target of control commands) because of the range of adjustment possibilities and the items of status information that must be accordingly displayed to an operator in the case of complex modern apparatuses (for example industrial machines or systems). Usually two-dimensional displays are used that include display elements as information. For this purpose the only conventional approaches are either to integrate additional display devices into the control device or to provide display devices with switch-over functions. This requires an exchange of existing display elements or augmentation thereof. The size of the display devices and the expansion capability are limited due to structural limitations, as well as cost reasons. The capability of switching between different items of information that are to be presented is complicated with regard to the time cost and the operator education that is required.

It is specifically in the case of control tasks that an additional problem arises of control elements frequently being used for all individually provided display devices, for example two or more control keyboards and the like.

In the field of control devices, it has additionally been proposed to use three-dimensional display devices, with eyewear known as shutter glasses being used.

### SUMMARY OF THE INVENTION

An object of the invention is to provide a device that is designed to simultaneously display information (in particular information originating from different sources) at a single display device, and that can be realized at low cost.

This object is achieved in accordance with the invention by a device for simultaneous presentation at a single display device of at least two items of information respectively associated with a person to respective persons located at different positions wherein, in order to present the information using the entire presentation area of the display device so that the information is visible only from the respective position, the display device is provided with a lenticular film that is designed to depict an image point (pixel) presented at the display device at an associated position.

In the case of a device to control a target device that includes a display device such as a monitor on which at least two different control presentations can be presented as information, according to the invention for simultaneous presentation of the information using the entire presentation area of the display device so that the information is respectively perceptible by variation of the position of the head of an operator, the display device is provided with a lenticular film that is designed to depict an image point (pixel) presented at the display device at an associated position of the head.

The basic idea of the present invention is thus to use a lenticular film in order to be able to show the information at different observation positions but essentially simultaneously. Lenticular films are widely known. Such films have oblong, adjoining lens segments that have a slight transverse expansion, which means that the surface of the lenticular film has convex elevations extending in a first direction. These elevations follow one another in a second direction orthogonal to the first direction. The convex elevations, together with base film bodies that may be located below them, ultimately act like longitudinally extended magnification lenses that—depending on position—convey different items of information therethrough that are arranged on the side opposite the convex elevations.

If stripes of different images (for example stripes of two different images) that run in the first direction are now arranged below the lenticular film (thus facing away from the convex elevations) so that stripes of all images of identical size are always positioned identically below a lens segment, positions exist in which the first image is visible and positions exist in which the second image is visible. The use of lenticular films thus functions according to the known “shaking image technique”, in which a generated combination image to which a lenticular film is adhered can show one of the two combined input images by tilting thereof. The relative position of the combination image provided with the lenticular film and the eye of the viewer is consequently varied by the tilting. The use of lenticular films can also be employed in order to generate 3D images, wherein the imaging optics of the lens segments of the lenticular film are then selected so that one eye of a viewer sees one input image at a defined distance but the other eye sees the other input image. With regard to “shaking images”, it is also known to use more than two input images. Ultimately in the case of lenticular films, the viewing direction (consequently the relative position of the viewer) thus determines which image the viewer actually sees.

In accordance with the invention, such lenticular films are used in applications in which different items of information should be simultaneously presented at a single display device, and wherein the entire area of the display device should be used. The display device, namely a monitor or a display, is provided with a lenticular film, which means that the lenticular film can be adhered to the presentation area, for example. The lenticular film forms the basis of a suitable optical element in order to make specific image points of the display device visible from specific positions, for example from the positions at the presentation device that are respectively associated with the different persons, or from different head positions at the control device. With the known optical properties of the lenticular film, the display device can now be controlled so that information that should be visible at specific positions is assigned to the corresponding image points of the display device (consequently is displayed there).

A device according to the invention also has a combination device to combine input images containing the information into a combination image to be presented on the display device. In order to determine the combination image to be displayed (which combination image will ultimately be formed by “stripes” of the input images that are situated next to one another), computer programs that are known in the art (for example for the generation of shaking images and the like) can be used. Thus a computer program can be stored on the combination device as software that merges the different input signals (input images), so as to appropriately mix them. If the longitudinal lens segments of the lenticular film run in the line direction, lines derived from the first input image and lines derived from the second input image (and also lines that were derived from additional input images, in the case of more than two input images) always also follow one another in alternation. The same accordingly applies when the lenticular film has line segments extending in the column direction of the display device.

Because it may be the case that the input images have different parameters (for example different pixel sizes, different width and height and the like), a computer program can be provided to adapt differently parameterized input images to an input image standard, and thus this program or routine can be stored on the computer device. This means that a type of input module can be realized that initially determines the parameters of the input images, for example pixel size, number of lines and number of columns. This image information is then processed and an adaptation of the input images ensues. For example, the resolution of the images can be varied and the like. For the combination image, the input images are mixed together in stripes (in the line or column direction depending on the application) into a combination image depending on the output parameters, in particular dependent on the optical properties of the film and the display device that is used, and this combination image is displayed on the display device.

A person thus sees different information on the same presentation area depending on from which position he or she views the display device. If a fine adjustment is still required, a device according to the invention can also have at least one mechanism and/or electronic means for fine adjustment of the association with the positions, which in particular operates via displacement of a screen presentation of the display device and/or relative displacement of the display device and the lenticular film. An adjustment to specific positions and regions can then also be optimized.

A number of advantages are achieved via the present invention. Lenticular films are widely known and are readily available in quantity and inexpensively in different versions and sizes. Existing display devices—in particular monitors and displays—can continue to be used and are easily extended into a device according to the invention by the lenticular film and suitable software. The use of expensive 3D monitors and/or shutter glasses is unnecessary, as is the complicated integration of additional display devices. The invention is easily adaptable to existing products and can be used universally without the respective existing installation structure needing to be changed. Within the scope of the present invention, it is also possible to realize auxiliary modules for mobile telephones, computers and the like, for example.

With regard to the control device, it is also advantageous that complex switching routines between different items of information (control menus, for example) are not required. The operator intuitively holds his or her head position so that he or she can perceive the presently desired information.

The presentation device according to the invention can be integrated into an office desk, so the aforementioned viewing positions correspond to opposite sides of the office desk. For example, a display that is integrated flat into a desk can be provided as a display device, so persons located on different sides (in particular the long sides) of the desk can respectively perceive the information that is associated with (relevant to) those different persons, and this occurs simultaneously. For example, a physician positioned behind the office desk can view a patient file of the patient who is located on the other side of the desk, while the patient, due to his or her position and the special optics of the lenticular film, sees an x-ray image that the physician would like to use in order to explain something to the patient. A similar situation is provided when, for example, a student/teacher configuration is present, consequently when a teacher is located behind the desk and a student (who, for example, should initially not perceive background information belonging to the teacher) is located in front of the desk. A number of useful applications are thus possible with such a desk that includes a presentation device according to the invention.

In a further embodiment of both the control device and the presentation device, it includes at least one operating element provided in the region of the presentation area. In this way, an operation directly at the device is possible, which proves to be extremely helpful in the case of the control device. In general, an inductive and/or capacitive operating element or an operating element operating with a pressure sensor can be provided as such an operating element on and/or in and/or below the film.

According to the invention, it is preferred for the at least one operating element (which can function in the manner of a button, for example) to be integrated into the lenticular film itself. In an embodiment of this aspect of the invention, the inductive and/or capacitive operating element can include wires running within the lenticular film, such as wires running along transitions between adjacent lens segments. Wires with which the proximity of a finger or the like can be detected inductively and/or capacitively can be arranged in the edge regions of the lens segments, for example along the depressions of the convex elevations where the optical properties of the lenticular film can be distorted as little as possible. The paths of such wires can also be oriented on the paths of the boundaries of pixels of a pixel matrix of the display device. The lenticular film in this embodiment is designed to be rather hard (meaning less elastic) so that the optical properties are affected as little as possible even upon contact with the lenticular film.

Alternative embodiments are also conceivable (that are less preferable, however) in order to realize operating elements. For example, an elastic lenticular film can be used, below which are arranged pressure sensors. An additional possibility is to cast the lenticular film in a transparent resin (optimally so that the optical properties of said lenticular film do not change) on or in which control elements can be realized, for example as a form of “touchscreen”.

In a preferred embodiment of the present invention, the at least one operating element is designed to detect an operating direction (in particular a movement direction of a controlling finger and/or operating tool during the movement), and a control device associated with an input is provided that uses the operating direction in order to cause an item of information associated therewith to be shown. The idea underlying this embodiment is that, in principle, it is unclear to which item of shown information an input via the operating elements relates. For example, if an entry of control commands should take place at a control device, and if a button for use in triggering a control command is presented at the same position of the display device for both presentable items of information, a differentiation mechanism is required in order to enable a correct association of the input with an item of information. In this embodiment, not only is an input position detected, but also, as auxiliary information a movement direction leading to the input or during the input is detected. This auxiliary information can then be associated with a particular item of information. This avoids the ambiguity that would otherwise exist when the input could be meaningfully used for both shown items of information.

In a further embodiment of the control device, two different control menus are presented as information, one control menu when the observer views the display device from the left (first head position) and one control menu when the operator views the display device from the right (second head position). When the movement direction is to the left the input can then accordingly be associated with the menu visible to the right, and when the movement direction is to the right the input can be associated with the menu visible from the left. An elegant possibility for differentiation is thus provided that, which can be supplemented by the control device through context analyses and the assessment of at which positions reasonable inputs are possible.

Such an embodiment that detects movement directions can also be realized by a presentation device according to the invention.

As a specific example, detection of an operating direction can be implemented by arranging at least two operating elements next to one another (in particular a matrix of operating elements), and the operating direction can be determined from an activation sequence of adjacent operating elements. In this case, the operating elements are thus ultimately differentiable as individual “buttons”, and the order (sequence) of their activation defines an operating direction. In principle, it is conceivable to use any suitable operating elements (for example of a capacitive and/or inductive type) that can also track a position (of a moving finger or another operating utensil, for example) over time.

It should be noted that, in principle, it is also conceivable to evaluate the movement in more than two directions, and to make corresponding associations.

### BRIEF DESCRIPTION OF THE DRAWINGS

FIG. 1 illustrates components of a presentation device according to the invention.

FIG. 2 shows a presentation device integrated into an office desk.

FIG. 3 is a block diagram of a control device according to the invention.

FIG. 4 illustrates an embodiment of operating elements in a device in accordance with the invention.

FIG. 5 illustrates the detection of operating directions in a device in accordance with the invention.

### DESCRIPTION OF THE PREFERRED EMBODIMENTS

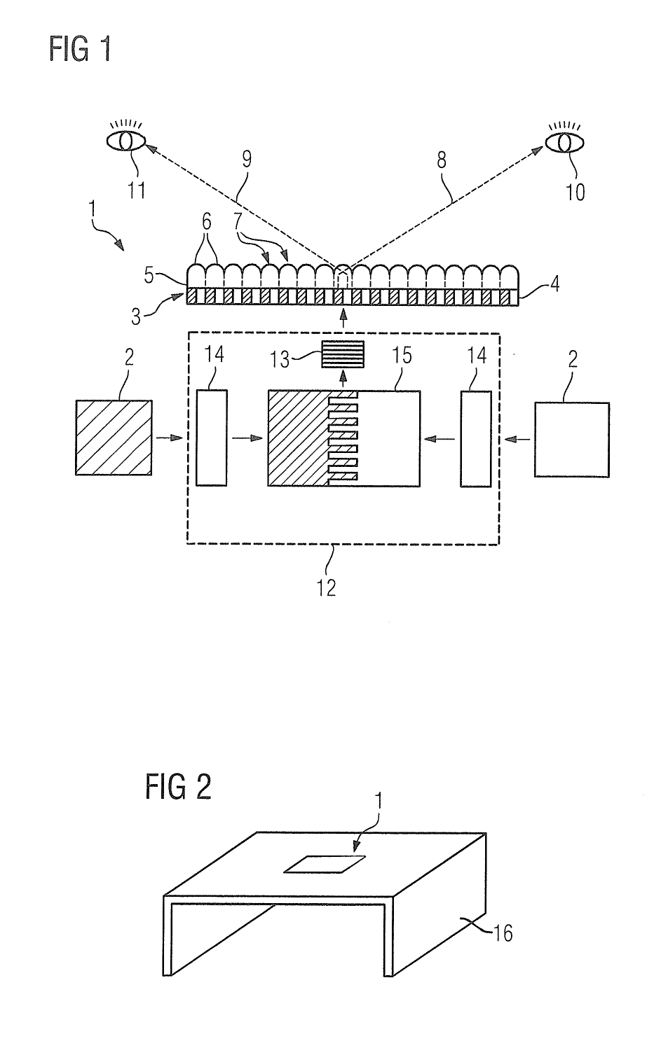

FIG. 1 shows the basic components of a presentation device 1 according to the invention with which different information (present as schematically depicted input images 2) are presented simultaneously at a display device 3 (here a display 4).

For this purpose, a lenticular film 5 is applied on the display device 3, which lenticular film 5, as is known, has convex elevations 6 arranged in parallel, extending in the longitudinal direction so that lens segments 7 are formed. These have a magnifying effect and permit only a portion of the information that is physically beneath a lens segment 7 to be seen through (i.e. at the opposite side of) the lens segment 7, depending on the viewing direction (thus the position) of a viewer, as illustrated in an example indicated by arrows 8 and 9 and eyes 10 and 11. If the display device 3 is viewed from the position of the eye 10, the image points that are schematically indicated by shading are seen. If one is located at the position of the eye 11, the image points that are indicated by not being shaded are seen.

In order to cause information associated with a particular person to be presented to respective persons at the respective positions of the eyes 10 and 11, the presentation device 1 has a combination device 12 in which the input images 2 are combined into a combination image 13, by these images 2 being initially, optionally adapted (in terms of their resolution and size) to one another and to the display device 3 in input modules 14. A computer program that is stored in the computer device 12 combines the input images (which may have been processed, if necessary, in the input modules 14) so that image information of the one input image 2 (shown shaded) and the other input image 2 follow one another in alternating stripes, as is schematically shown by the illustration 15. The combination image 13 that arises in such a manner is then presented at the display device 3 so that, due to the known optical effect of the lenticular film 5, information of the shaded input image 2 is perceived at the position of the eye 10 (i.e. from its viewing direction), while information of the unshaded partial image 2 is seen at the position of the eye 11. Fine adjustment means (not shown in detail) can be provided for fine adjustment.

The presentation device 1 can be advantageously used when persons having different roles (for which different items of information are designated) are respectively located at different determinable positions relative to the display device 3.

FIG. 2 shows an office-type desk 16 in which a presentation device 1 is integrated in the horizontal surface thereof. If a physician takes a seat behind the desk and a patient takes his or her place in front of the desk, for example, the unannotated x-ray image can be displayed to the patient but at the same time, while still using the entire presentation area, an annotated version (containing the physician's comments) or a patient file of the patient can be presented to the physician. Such a desk 16 with a presentation device 1 can also be used for student/teacher discussions, job interviews and the like.

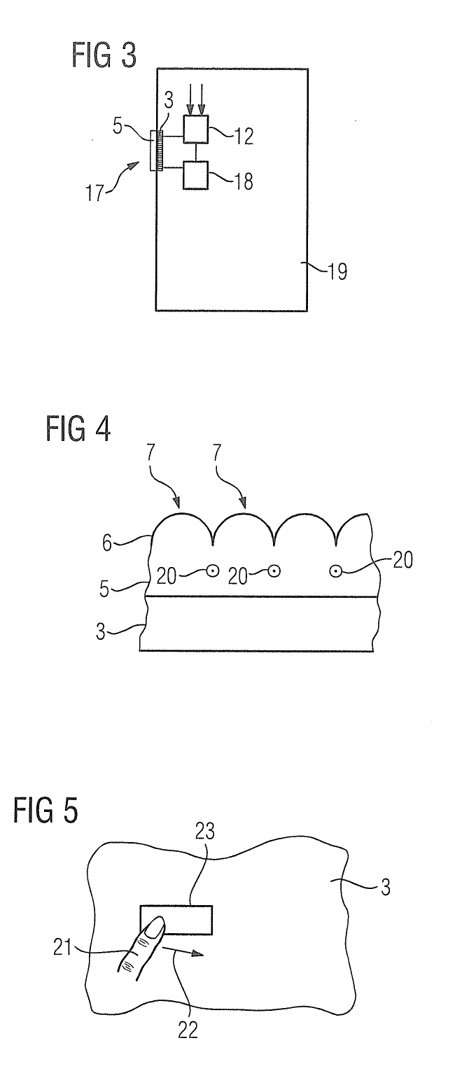

FIGS. 3-5 show a control device 17 according to the invention that is integrated into the device to be controlled (the target device 19), for example an industrial machine or the like. The display device 3 is located so as to be clearly visible on the front side of the target device 19, with the lens segments of the lenticular film 5 is vertically oriented. Because the principle as presented with regard to FIG. 1 is maintained, a viewer (such as an operator of the target device 19) now sees different information (here a different control menu) when he or she views the display device 3 from the right than when he or she views the display device from the left. A combiner device 12 is provided, as described above, that receives input images (here control presentations, in particular control menus) from two signal sources and produces a combination image dependent on the optical properties of the lenticular film 5 and the parameters of the display device 3. This combination image allows the simultaneous presentation of (for example) two control menus that can also include status information, selection buttons and the like. The overall operation of the control device 17 is controlled by a control device 18 (which can also be the source of the input images), with operating elements in order to accept control instructions (thus inputs) being integrated into the control device 17, as explained in detail with regard to FIGS. 4 and 5.

FIG. 4 shows one embodiment of such operating elements, by integration into the lenticular film 5. Wires 20 that are part of the operating element are directed through the lenticular film 5 at the transitions between adjacent lens segments 7. With the wires 20, the presence of a dielectric (in particular a finger) can be measured capacitively and/or inductively. Other possibilities to realize such operating elements are also conceivable.

In this exemplary embodiment, in every case the operating elements are designed to also detect an operating direction (for example the movement direction of a finger). For example, the path of a detected position of a finger 21 over the display device 3 (thus also the lenticular film 5) can be tracked. In the example shown in FIG. 5, the finger is moved with the operating direction “to the right” (arrow 22) over a depicted control surface (button) 23. The operating direction is now used in order to associate that input action with one of the items of information, for example one of the presented control menus. This occurs via the control device 18. If it is detected that the finger 21 is moved to the right, it is assumed that the operator views the display device 3 from the left and that the detected input consequently relates to the information visible from the left position. The same accordingly applies in reverse for the operating direction “to the left”. Not only is a selection of simultaneously presented information possible in a simple, intuitive manner by movement of the head, but a similarly intuitive operating concept is additionally realized so that the control of target devices 19 is markedly simplified.

The presentation device or control device according to the invention can be particularly advantageously applied in a cockpit of an aircraft (in particular a fighter jet). A multitude of items of information must be communicated in fighter aircraft, for which only a limited number of display devices are available. Instead of needing to laboriously switch between multiple display devices, using the present invention it is now possible to view different information extremely quickly (meaning with a speed advantage when changing from viewing one information item to the next) simply by nodding one's head. The described operating concept can then also be used advantageously.

Although modifications and changes may be suggested by those skilled in the art, it is the intention of the inventor to embody within the patent warranted hereon all changes and modifications as reasonably and properly come within the scope of his contribution to the art.

I claim as my invention:

1. A device to simultaneously present at least two items of information to respective, differently situated viewers, comprising:
a single display area containing at least two different humanly perceptible optical items of information;
a lenticular film covering an entirety of said display area; and
said lenticular film being configured to permit viewing of only a first of said items of information from a first viewing direction and viewing of only a second of said items of information from a second viewing direction that is different from said first viewing direction.

2. A device as claimed in claim 1 comprising an office-type desk having a horizontal surface in which said display area is integrated, and wherein said first and second viewing directions are located respectively at opposite sides of said horizontal surface, higher than said horizontal surface.

3. A device as claimed in claim 1 wherein said display area comprises at least one operating element configured to designate, upon actuation thereof, which of said items of information is presented at said display area.

4. A device as claimed in claim 3 wherein said operating element is selected from the group consisting of inductive operating elements and capacitive operating elements.

5. A device as claimed in claim 4 wherein said operating element comprises a plurality of wires proceeding within said lenticular film.

6. A device as claimed in claim 5 wherein said lenticular film comprises a plurality of adjacent lens segments respectively having transitions therebetween, and wherein said wires proceed along said respective transitions.

7. A device as claimed in claim 3 wherein said operating element is a pressure sensor.

8. A device as claimed in claim 3 wherein said operating element is located at a position selected from the group consisting of in said lenticular film, on said lenticular film, and below said lenticular film.

9. A device as claimed in claim 3 wherein said operating element is configured to detect an operating direction of a finger or operating utensil during movement of said finger or operating utensil, and wherein said device comprises a control unit configured to select an item of information to be presented at said display area dependent on the detected direction of said movement.

10. A device as claimed in claim 9 comprising at least two operating elements located next to each other, and wherein said control unit is configured to detect said operating direction by an actuation sequence of the respective at least two adjacent operating elements.

11. A device as claimed in claim 1 wherein said items of information are respective images, and wherein said device comprises a combination unit configured to combine said respective images into a single combination image and to present said single combination image at said display area beneath said lenticular film.

12. A device as claimed in claim 11 wherein said respective images are differently parameterized, and wherein said combination unit is configured to adapt the differently parameterized images to each other according to an image standard, and to generate said combination image with said image standard.

13. A device as claimed in claim 11 comprising at least one image adjustor configured to adjust a positional relationship between said combination image and said lenticular film.

14. An apparatus comprising:
a controllable target device;
a control unit configured to operate said controllable target device according to at least two different control presentations;
a single display area at which said two different control presentations are simultaneously displayed, each of said at least two different control presentations occupying an entirety of said display area; and
a lenticular film covering said entirety of said display area, said lenticular film being configured to cause only a first of said at least two different control presentations to be viewed from a first position of the head of a viewer, and to permit only a second of said at least two different control presentations to be viewed from a second position of the head of the viewer.
